(19) United States
(12) Patent Application Publication
(10) Pub. No.: US 2020/0202237 A1
(43) Pub. Date: Jun. 25, 2020

(54) STATE MANAGEMENT SYSTEM AND STATE MANAGEMENT METHOD

(71) Applicant: FUJITSU LIMITED, Kawasaki-shi (JP)

(72) Inventors: Takashi ENAMI, Kawasaki (JP); Noriyuki FUKUYAMA, Kawasaki (JP); MAKOTO KUBOTA, Kawasaki (JP); Nami Nagata, Kawasaki (JP)

(73) Assignee: FUJITSU LIMITED, Kawasaki-shi (JP)

(21) Appl. No.: 16/708,867

(22) Filed: Dec. 10, 2019

(30) Foreign Application Priority Data
Dec. 19, 2018 (JP) 2018-237378

(51) Int. Cl. G06N 5/04; G06N 7/00; G06N 20/00

(52) U.S. Cl. CPC G06N 5/04; G06N 20/00; G06N 7/005

(57) ABSTRACT

A state management system includes an information processing apparatus including a first memory, and a first processor coupled to the first memory and the first processor configured to execute processing, and a management apparatus including a second memory, and a second processor coupled to the second memory and the second processor configured to predict a completion time of the processing in the information processing apparatus in accordance with information transmitted from the information processing apparatus wherein the first processor is configured to change, in accordance with a completion rate of the processing, a threshold for a difference between an actual state of the information processing apparatus and a state of the information processing apparatus recognized by the management apparatus, and transmit the information to the management apparatus when the difference exceeds the threshold.

### CROSS-REFERENCE TO RELATED APPLICATION

This application is based upon and claims the benefit of priority of the prior Japanese Patent Application No. 2018-237378, filed on Dec. 19, 2018, the entire contents of which are incorporated herein by reference.

### FIELD

The embodiments discussed herein are related to a state management technology.

### BACKGROUND

With the progress of Internet of things (IoT), the amount of data generated by end devices has increased, making it difficult to process all data and control devices in the cloud. For this reason, attention is focused on the distributed processing environment based on edge computing. This edge computing is a technique for distributing a load and reducing communication delay by arranging a plurality of edge apparatuses near a user on a computer network.

As related art, in a server-client type system, a client apparatus includes a timer for measuring a predicted processing time, sets a predicted processing time corresponding to a processing request from the client apparatus calculated by a server to the timer, and sends a state acquisition request to the server for the first time at the time of time-out.

For example, Japanese Laid-open Patent Publication No. 2002-358282 discloses related art.

### SUMMARY

According to an aspect of the embodiments, a state management system includes an information processing apparatus including a first memory, and a first processor coupled to the first memory and the first processor configured to execute processing, and a management apparatus including a second memory, and a second processor coupled to the second memory and the second processor configured to predict a completion time of the processing in the information processing apparatus in accordance with information transmitted from the information processing apparatus wherein the first processor is configured to change, in accordance with a completion rate of the processing, a threshold for a difference between an actual state of the information processing apparatus and a state of the information processing apparatus recognized by the management apparatus, and transmit the information to the management apparatus when the difference exceeds the threshold.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram illustrating a system configuration example of an information processing system;

FIG. 2 is an explanatory diagram illustrating an example of a temporal change in processing completion rate;

FIG. 3 is a block diagram illustrating a hardware configuration example of an edge apparatus;

FIG. 4 is an explanatory diagram illustrating a specific example of correction information;

FIG. 5 is an explanatory diagram illustrating an example of contents stored in a processing progress log DB;

FIG. 6 is an explanatory diagram illustrating an example of contents stored in a data storage information DB;

FIG. 7 is an explanatory diagram illustrating an example of contents stored in an edge state DB;

FIG. 8 is a block diagram illustrating a functional configuration example of a management apparatus;

FIG. 9 is an explanatory diagram illustrating an example of correcting an error related to the state of the edge apparatus;

FIG. 10 is a block diagram illustrating a functional configuration example of the edge apparatus;

FIG. 11 is an explanatory diagram illustrating an example of a threshold function;

FIG. 12 is an explanatory diagram illustrating an example of the error related to the state of the edge apparatus;

FIG. 13 is an explanatory diagram illustrating an example of a method of calculating a slope;

FIG. 14 is an explanatory diagram illustrating an example of adjusting a threshold;

FIG. 15 is a flowchart illustrating an example of a state management processing procedure of the management apparatus;

FIG. 16 is a flowchart illustrating an example of an execution processing procedure of the edge apparatus;

FIG. 17 is a flowchart illustrating an example of a specific processing procedure of correction information notification processing;

FIG. 18 is a block diagram illustrating a functional configuration example of a management apparatus according to Embodiment 2;

FIG. 19 is an explanatory diagram illustrating an example of contents stored in a threshold function information DB;

FIG. 20 is an explanatory diagram illustrating an example of determining a threshold function;

FIG. 21 is a flowchart illustrating an example of a state management processing procedure of the management apparatus; and

FIG. 22 is a flowchart illustrating an example of a specific processing procedure of threshold control processing.

### DESCRIPTION OF EMBODIMENTS

The prior art has a problem that the amount of information notified from an edge apparatus is increased in order to grasp the state of an edge apparatus on the cloud side, leading to increased communication traffic.

Hereinafter, with reference to the drawings, embodiments of an information processing system and an information processing apparatus according to the embodiments will be described in detail. First, a system configuration example of an information processing system 100 according to Embodiment 1 will be described. The information processing system 100 is applied to, for example, a distributed processing environment based on edge computing. The information processing system 100 is an example of a state management system.

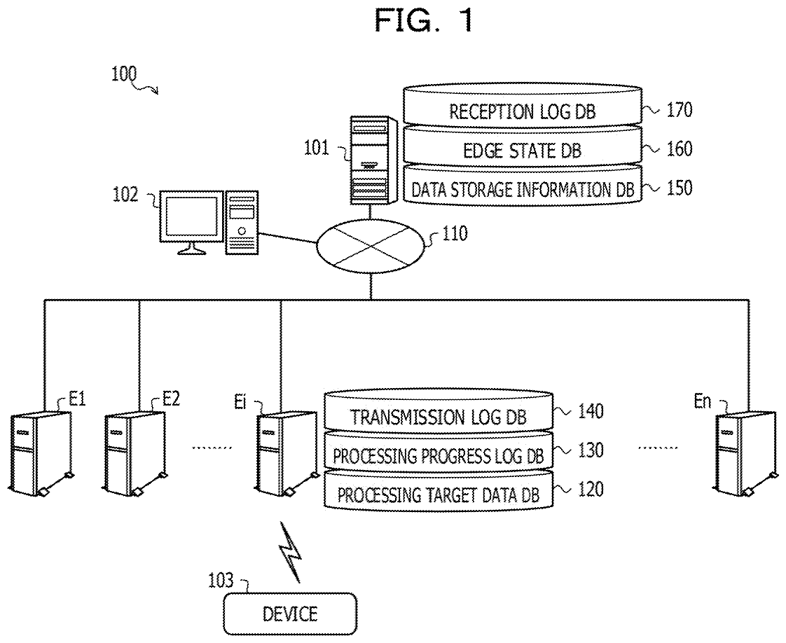

FIG. 1 is an explanatory diagram illustrating the system configuration example of the information processing system 100. In FIG. 1, the information processing system 100 includes edge apparatuses E1 to En (n: a natural number equal to or greater than 2), a management apparatus 101, and a client apparatus 102. In the information processing system 100, the edge apparatuses E1 to En, the management apparatus 101, and the client apparatus 102 are coupled to each other via a wired or wireless network 110. The network 110 is, for example, a local area network (LAN), a wide area network (WAN), the Internet, or the like.

In the following description, an arbitrary edge apparatus among the edge apparatuses E1 to En is referred to as “edge apparatus Ei (i=1, 2, . . . , n) in some cases.

The edge apparatus Ei is an information processor (computer) that executes processing. For example, the edge apparatus Ei is a server, a gateway device, an access point, a personal computer (PC), or the like. The processing is, for example, processing on data transmitted from a device 103.

The device 103 is, for example, an automobile sensor, a device sensor, an environment sensor, a camera, or the like. The data transmitted from the device 103 is, for example, sensing data of various sensors, images captured by a camera, and the like. Examples of processing on such data include processing of analyzing and calculating the sensing data, processing of analyzing the images, and the like.

In the following description, processing executed by the edge apparatus Ei may be referred to as “processing Pi”. The edge apparatus Ei includes a processing target data database (DB) 120, a processing progress log DB 130, and a transmission log DB 140. The processing target data DB 120 stores data to be processed. The data to be processed is, for example, data transmitted from the device 103.

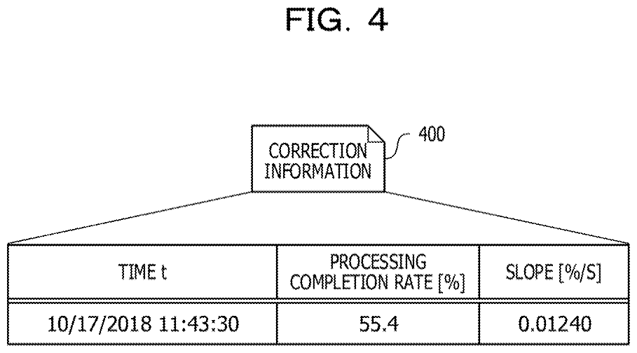

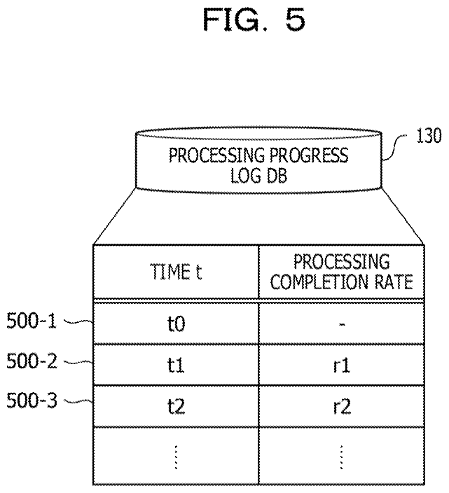

The processing progress log DB 130 stores a log indicating the progress of the processing Pi. The contents stored in the processing progress log DB 130 will be described later with reference to FIG. 5. The transmission log DB 140 stores a log related to information (for example, correction information 400 illustrated in FIG. 4 to be described later) transmitted from the edge apparatus Ei to the management apparatus 101.

The management apparatus 101 is an information processor (computer) that manages the state of each edge apparatus Ei. The state of the edge apparatus Ei is, for example, a completion rate of the processing Pi, the amount of change per unit time of the completion rate of the processing Pi, or the like. Also, the management apparatus 101 predicts the completion time of each processing Pi based on information notified from each edge apparatus Ei. For example, the management apparatus 101 is a cloud computing server.

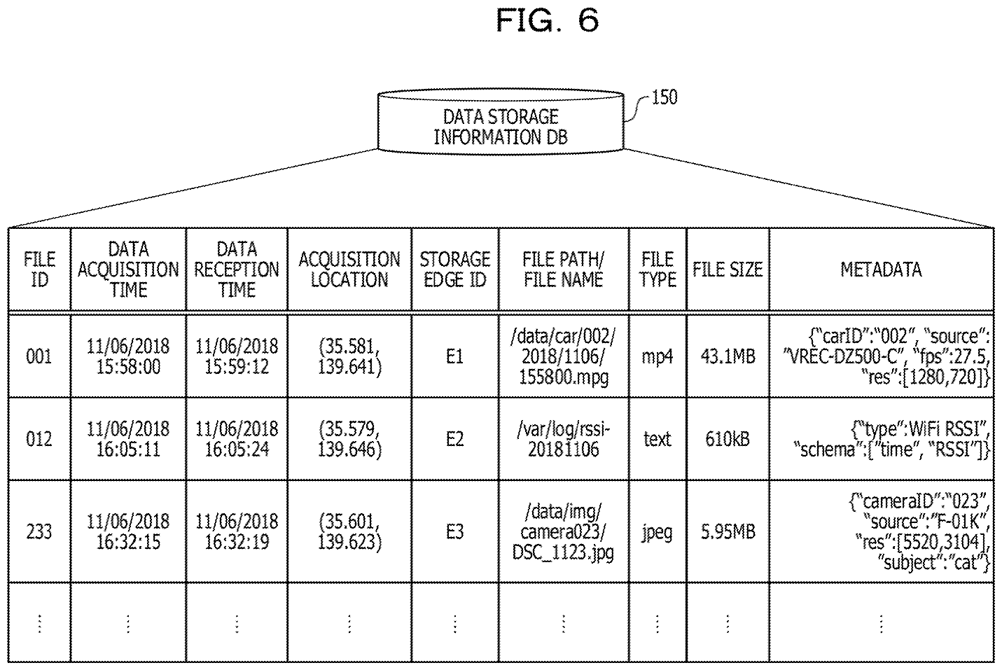

The management apparatus 101 includes a data storage information DB 150, an edge state DB 160, and a reception log DB 170. The data storage information DB 150 stores information indicating a storage location of data to be processed. The contents stored in the data storage information DB 150 will be described later with reference to FIG. 6.

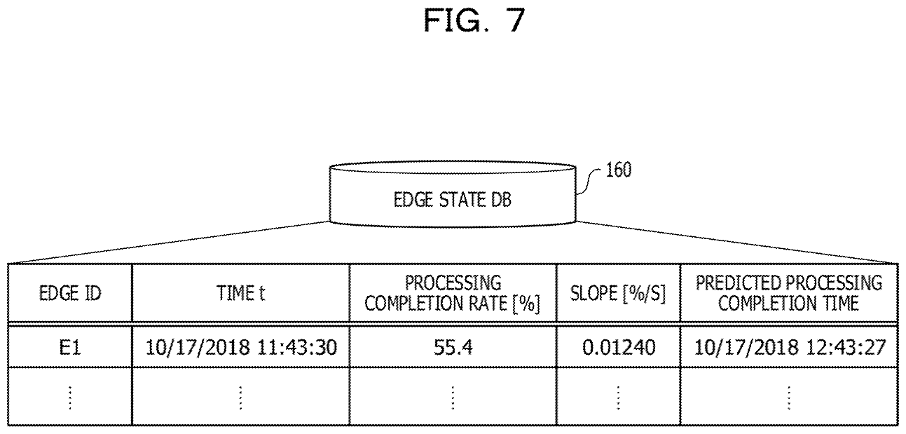

The edge state DB 160 stores information about the states of the edge apparatuses E1 to En. The contents stored in the edge state DB 160 will be described later with reference to FIG. 7. The reception log DB 170 stores a log related to information (for example, correction information) received from the edge apparatus Ei.

The client apparatus 102 is a computer used by a user of the information processing system 100. For example, the user uses the information processing system 100 to analyze or assay data obtained from the device 103. For example, the client apparatus 102 is a PC, a tablet PC, a smartphone, or the like.

Communication traffic flowing through a wide area network may be reduced by so-called data proximity processing wherein data itself is not sent to the cloud side (for example, the management apparatus 101) but only the result of processing executed on the data by the edge apparatus (for example, the edge apparatus Ei) is sent to the cloud side.

Upon construction of a system in which such an edge apparatus and the cloud operate in a coordinated manner, management of the state of each edge apparatus on the cloud side is important to grasp the progress of processing of each edge apparatus. For example, in order to manage the state of the edge apparatus on the cloud side, it is conceivable to notify the cloud side every time processing (one process) is completed at the edge apparatus.

However, the processing executed by the edge apparatus often has a characteristic that although each process ends in an instant, it takes time to complete a large number of processes. Therefore, sending information about the state of the edge apparatus to the cloud side upon every completion of the process leads to increased communication traffic.

For this reason, it is conceivable to reduce the communication traffic by limiting the information about the states of the edge apparatuses sent to the cloud side. For example, in the cloud, the state of the edge apparatus is calculated using limited information notified from the edge apparatus. In the edge apparatus, the state of the edge apparatus calculated by the cloud is obtained by the same calculation, and only when a difference between the actual state grasped by the edge apparatus and the state obtained by the calculation is increased, correction information about the state of the edge apparatus is notified to the cloud.

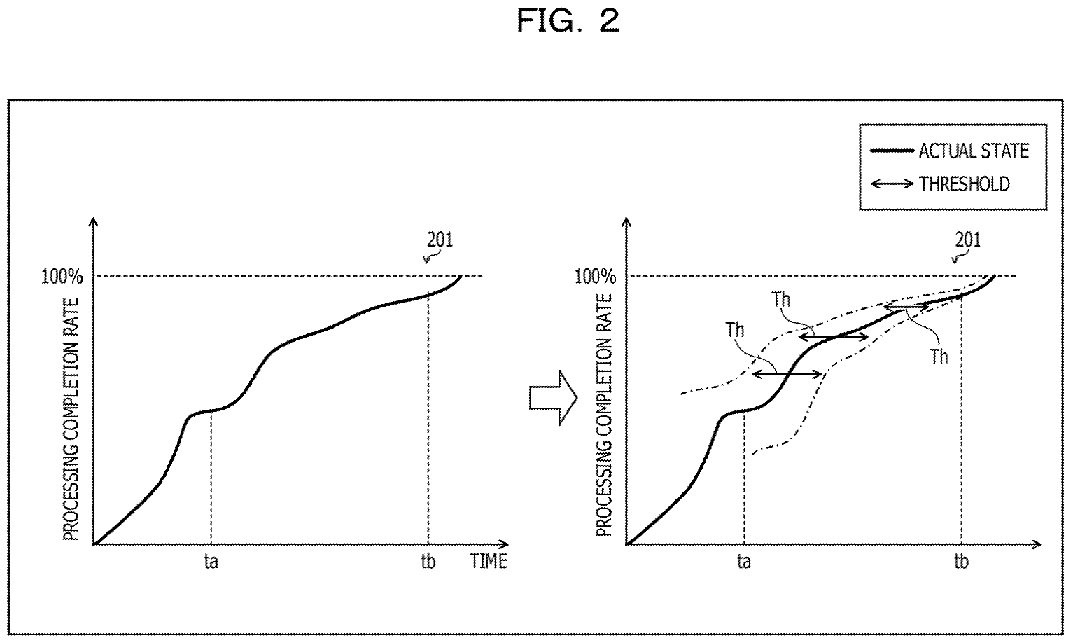

However, from the user's point of view, as illustrated in FIG. 2, he/she tends to want a roughly stable prediction result at an intermediate time and a highly accurate prediction result just before completion, as the prediction result of the processing completion time at the edge apparatus.

FIG. 2 is an explanatory diagram illustrating an example of a temporal change in processing completion rate. In FIG. 2, a graph 201 represents a temporal change in processing completion rate in the edge apparatus. At an intermediate time ta, the user is pleased when a prediction result is obtained with a granularity of, for example, after 5 to 6 hours, and is confused when the prediction result fluctuates significantly such as after 3 to 24 hours.

On the other hand, at a time tb just before the completion, even if the prediction changes finely, the user is pleased when a prediction result reflecting the current state of the edge apparatus is obtained, and gets perplexed, for example, when the processing is actually still being executed and it takes another hour to complete, even though processing completed is displayed. For example, it may be said that the prediction accuracy required by the user differs depending on which stage the processing is at between the start of the processing and the completion of the processing.

Therefore, in this embodiment, the edge apparatus Ei adjusts a threshold Th used to determine whether to notify the management apparatus 101 of correction information about its own state, according to the completion rate of the processing Pi. The threshold Th is a threshold of a difference between the state of its own recognized by the edge apparatus Ei and the state of the edge apparatus Ei recognized by the management apparatus 101, that is, an error of the state of the edge apparatus Ei recognized by the management apparatus 101.

Accordingly, the frequency of notifying the correction information about the state of the edge apparatus Ei may be controlled to realize an effective notification frequency for the situation. For example, the frequency of notifying the correction information to the management apparatus 101 may be reduced as the threshold Th is increased. In this case, although the prediction accuracy tends to be lowered, the communication traffic related to the state notification to the management apparatus 101 may be reduced. Furthermore, the frequency of notifying the correction information to the management apparatus 101 may be increased as the threshold Th is decreased. In this case, although the communication traffic related to the state notification to the management apparatus 101 is increased, the prediction accuracy may be improved.

In the example of FIG. 2, the edge apparatus Ei makes an adjustment such that the threshold Th is decreased as the completion rate of the processing Pi is increased. Thus, the frequency of notifying the correction information to the management apparatus 101 may be suppressed to reduce an increase in communication traffic from the start of the processing to around the intermediate time. On the other hand, as the processing comes close to its completion, the prediction accuracy may be improved by increasing the frequency of notifying the correction information to the management apparatus 101.

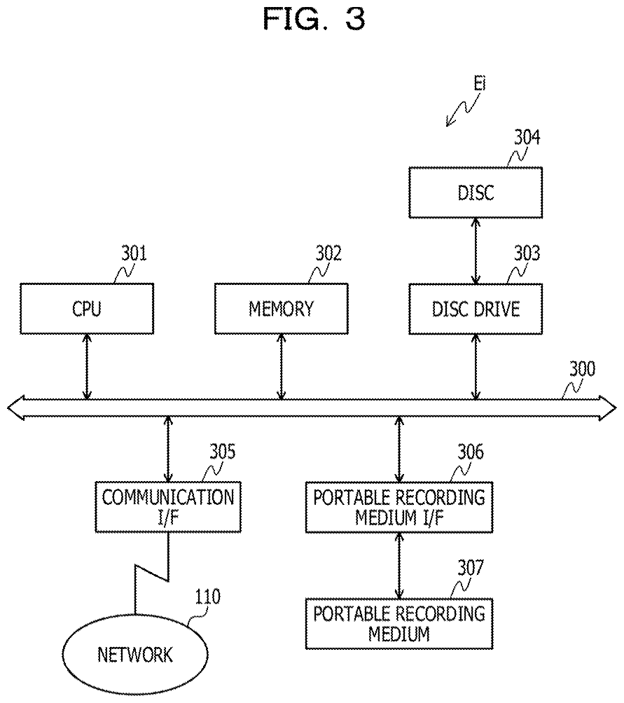

FIG. 3 is a block diagram illustrating a hardware configuration example of the edge apparatus Ei. In FIG. 3, the edge apparatus Ei includes a central processing unit (CPU) 301, a memory 302, a disc drive 303, a disc 304, a communication interface (I/F) 305, a portable recording medium I/F 306, and a portable recording medium 307. These components are coupled to one another through a bus 300.

The CPU 301 controls the entirety of the edge apparatus Ei. The CPU 301 may include a plurality of cores. The memory 302 includes, for example, a read-only memory (ROM), a random-access memory (RAM), a flash ROM, and the like. For example, a flash ROM stores an operating system (OS) program, the ROM stores an application program, and the RAM is used as a work area of the CPU 301. The program stored in the memory 302 is loaded into the CPU 301, thereby causing the CPU 301 to execute coded processing.

The disc drive 303 controls read and write of data from and to the disc 304 according to the control of the CPU 301. The disc 304 stores the data written under the control of the disc drive 303. Examples of the disc 304 include a magnetic disc and an optical disc.

The communication I/F 305 is coupled to the network 110 via a communication line, and is coupled to an external computer (for example, the management apparatus 101 or another edge apparatus illustrated in FIG. 1) via the network 110. In addition, the communication I/F 305 functions as an interface between the network 110 and the inside of the device, and controls input and output of data from and to the external computer. As the communication I/F 305, for example, it is possible to adopt a modem, a LAN adapter, or the like.

The portable recording medium I/F 306 controls read and write of data from and to the portable recording medium 307 under the control of the CPU 301. The portable recording medium 307 stores the data written under the control of the portable recording medium I/F 306. Examples of the portable recording medium 307 include a compact disc (CD)-ROM, a digital versatile disk (DVD), a Universal Serial Bus (USB) memory, or the like.

In addition, the edge apparatus Ei may include, for example, a solid state drive (SSD), an input device, a display, and the like, in addition to the above-described configuration portions. Further, the edge apparatus Ei may not include, for example, the disc drive 303, the disc 304, the portable recording medium I/F 306, and the portable recording medium 307 among the components described above. The management apparatus 101 and the client apparatus 102 illustrated in FIG. 1 may also be realized by a hardware configuration similar to that of the edge apparatus Ei. However, the client apparatus 102 includes an input device, a display, and the like in addition to the components described above.

Next, a specific example of correction information about the state of the edge apparatus Ei notified from the edge apparatus Ei to the management apparatus 101 will be described with reference to FIG. 4. FIG. 4 is an explanatory diagram illustrating a specific example of correction information. In FIG. 4, the correction information 400 includes a time t, a processing completion rate, and a slope. The time t is the time when the processing completion rate is measured in the edge apparatus Ei. The time t may be represented by the elapsed time from the start of the processing Pi in the edge apparatus Ei.

The processing completion rate indicates a completion rate of the processing Pi at the time t (unit: [%]). The processing completion rate is represented, for example, by the ratio of processing (for example, processes) that are currently completed to the entire processing Pi (for example, a plurality of processes). The slope indicates a temporal change in the processing completion rate after the time t (unit: [%/s]). The slope is used, for example, to predict the processing completion rate after the time t. The predicted value is modeled by a linear expression.

Next, contents stored in the processing progress log DB 130 of the edge apparatus Ei will be described with reference to FIG. 5. The various DBs included in the edge apparatus Ei are realized, for example, by storage devices such as the memory 302 and the disc 304 illustrated in FIG. 3.

FIG. 5 is an explanatory diagram illustrating an example of the contents stored in the processing progress log DB 130. In FIG. 5, the processing progress log DB 130 has fields of time t and processing completion rate, and stores processing progress logs (for example, processing progress logs 500-1 to 500-3) as records by setting information in each field.

The time t is the time when the processing completion rate is measured in the edge apparatus Ei. The time t0 represents the processing start time. The time t may be represented by the elapsed time from the start of the processing Pi in the edge apparatus Ei. The processing completion rate indicates a completion rate of the processing Pi at the time t (unit: [%]).

Next, contents stored in the data storage information DB 150 included in the management apparatus 101 will be described with reference to FIG. 6. The various DBs included in the management apparatus 101 are realized, for example, by storage devices such as a memory and a disc in the management apparatus 101.

FIG. 6 is an explanatory diagram illustrating an example of the contents stored in the data storage information DB 150. In FIG. 6, the data storage information DB 150 has fields of file ID, data acquisition time, data reception time, acquisition location, storage edge ID, file path/file name, file type, file size, and metadata. By setting information in each field, data storage information (for example, data storage information 600-1 to 600-3) is stored as a record in the data storage information DB 150.

The file ID is an identifier that uniquely identifies data to be processed. A file will be described as an example of the data to be processed. The data acquisition time indicates the time when the data is acquired. The data is acquired, for example, by the device 103 illustrated in FIG. 1. The data reception time indicates the time when the data is received. For example, the data reception time is the time when the edge apparatus Ei receives the data transmitted from the device 103.

The acquisition location indicates the coordinates (for example, latitude and longitude) of the location where the data is acquired. The storage edge ID is an identifier that uniquely identifies the edge apparatus Ei that stores data. As the storage edge ID, for example, the name of the edge apparatus Ei, a fully qualified domain name (FQDN), an Internet protocol (IP) address, or the like is used.

The file path/file name indicates the data storage location/name. The file type indicates the type of data. The file size indicates the size of data. The metadata indicates the characteristics of the data. The metadata is used, for example, to determine what kind of processing may be executed.

Next, the contents stored in the edge state DB 160 included in the management apparatus 101 will be described with reference to FIG. 7. FIG. 7 is an explanatory diagram illustrating an example of the contents stored in the edge state DB 160. In FIG. 7, the edge state DB 160 has fields of edge ID, time t, processing completion rate, slope, and predicted processing completion time, and stores edge state information (for example, edge state information 700-1) as a record by setting information in each field.

The edge ID is an identifier that uniquely identifies the edge apparatus E. The time t is the time when the processing completion rate is measured in the edge apparatus Ei. The time t may be represented by the elapsed time from the start of the processing Pi in the edge apparatus Ei. The processing completion rate indicates a completion rate of the processing Pi at the time t (unit: [%]).

The slope indicates a temporal change in the processing completion rate after the time t (unit: [%/s]). The prediction process completion time is the time predicted to complete the execution of the processing Pi in the edge apparatus Ei. The edge state information may include, for example, a process start time at which the execution of the processing Pi is started in the edge apparatus Ei.

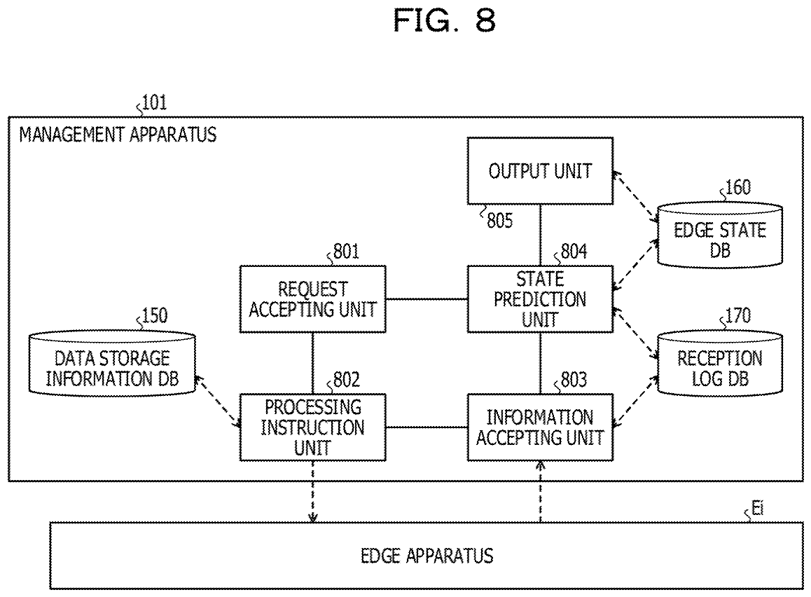

FIG. 8 is a block diagram illustrating a functional configuration example of the management apparatus 101. In FIG. 8, the management apparatus 101 includes a request accepting unit 801, a processing instruction unit 802, an information accepting unit 803, a state prediction unit 804, and an output unit 805. For example, the request accepting unit 801 to the output unit 805 realize their functions by causing the CPU to execute a program stored in the storage device such as the memory or disc in the management apparatus 101, or through a communication interface (I/F). The processing results from the respective functional units are stored, for example, in the storage device such as the memory or disc.

The request accepting unit 801 accepts a processing execution request. The processing execution request is a request to execute processing on data. The processing execution request includes, for example, information that specifies what kind of processing (analysis, assay, arithmetic processing, and the like) is to be performed on what kind of data.

For example, the request accepting unit 801 receives the processing execution request from the client apparatus 102 illustrated in FIG. 1 and thus accepts the received processing execution request. Alternatively, the request accepting unit 801 may accept a processing execution request through user operation input using an unillustrated input device.

The processing instruction unit 802 instructs the edge apparatus Ei to execute the processing Pi. For example, the processing instruction unit 802 refers to the data storage information DB 150 illustrated in FIG. 6 to specify the edge apparatus Ei that stores data to enable execution of processing specified from the processing execution request. Then, the processing instruction unit 802 transmits an instruction to execute the processing Pi specified from the processing execution request to the specified edge apparatus Ei.

The instruction to execute the processing Pi includes, for example, information that specifies data to be processed and processing contents of the processing Pi. Examples of the processing contents of the processing Pi include analysis, assay, arithmetic processing, and the like on the data to be processed. When a plurality of edge apparatuses are specified that store the data to enable execution of the processing specified from the processing execution request, the processing instruction unit 802 transmits the instruction to execute the processing to each of the plurality of edge apparatuses specified.

The information accepting unit 803 accepts information about the state of the edge apparatus Ei. The information about the state of the edge apparatus Ei is information for specifying the processing status of the processing Pi, including, for example, information that specifies the elapsed time from the start of the processing Pi and the completion rate of the processing Pi, information for predicting a temporal change in the completion rate of the processing Pi, and the like.

Examples of information about the state of the edge apparatus Ei include correction information and a process completion notification. The correction information is information notified to correct an error related to the state of the edge apparatus Ei recognized by the management apparatus 101, and is, for example, the correction information 400 illustrated in FIG. 4. The correction information includes, for example, information (initial notification) about the state first notified from the edge apparatus Ei after the execution of the processing Pi is started.

The processing completion notification is information notified from the edge apparatus Ei when the execution of the processing Pi is completed. Although not illustrated, the processing completion notification may be realized by the same data structure as the correction information 400 as illustrated in FIG. 4. In this case, the processing completion rate included in the processing completion notification is “100[%]”.

For example, the information accepting unit 803 receives information (correction information or processing completion notification) about the state of the edge apparatus Ei from the client apparatus 102 and thus accepts the received information. Upon receipt of the information (correction information or processing completion notification) from the edge apparatus Ei, a log related to the received information is recorded in, for example, the reception log DB 170 illustrated in FIG. 1.

The state prediction unit 804 predicts the state of the edge apparatus Ei based on the information accepted by the information accepting unit 803. For example, the state prediction unit 804 refers to the reception log DB 170 to specify the processing completion rate and the slope at the time t included in the correction information (latest correction information) notified from the edge apparatus Ei. Then, the state prediction unit 804 predicts a temporal change in the processing completion rate after the time t based on the processing completion rate and the slope at the specified time t.

For example, the state prediction unit 804 calculates a predicted processing completion time based on the processing completion rate and the slope at the time t included in the correction information. The predicted processing completion time is the time at which the execution of the processing Pi in the edge apparatus Ei is completed. Taking the correction information 400 illustrated in FIG. 4 as an example, an example of calculating the predicted processing completion time will be described.

First, the state prediction unit 804 calculates an elapsed time that takes the processing completion rate to reach 100[%] from 55.4[%] based on the processing completion rate “55.4[%]” and the slope “0.01240 [%/s]” Included in the correction information 400. The elapsed time is “3597 [s]”. Then, the state prediction unit 804 calculates the predicted processing completion time by adding the elapsed time “3597 [s]” to the time t included in the correction information 400. The predicted processing completion time is “10/17/2018 12:43:27”.

The predicted processing completion time predicted is stored, for example, in the edge state DB 160 illustrated in FIG. 7 in association with the time t, the processing completion rate, and the slope included in the correction information. For example, a notification source of the correction information 400 is the edge apparatus E1. In this case, the predicted processing completion time “10/17/2018 12:43:27” is set to each field of the edge state information of the edge apparatus E1 in association with the time t, the processing completion rate, and the slope included in the correction information 400.

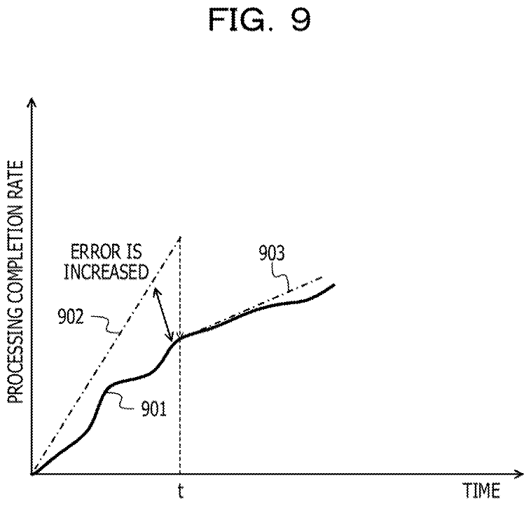

Thus, the error related to the state of the edge apparatus E1 recognized by the management apparatus 101 may be corrected. With reference to FIG. 9, an example of correcting an error related to the state of the edge apparatus Ei will be described. FIG. 9 is an explanatory diagram illustrating an example of correcting an error related to the state of the edge apparatus Ei. In FIG. 9, a graph 901 represents the actual state of the edge apparatus Ei. A graph 902 represents the state of the edge apparatus Ei recognized (predicted) by the management apparatus 101. It is assumed that the error related to the state of the edge apparatus Ei at the time t recognized by the management apparatus 101 is increased, and correction information is notified from the edge apparatus Ei to the management apparatus 101.

In this case, as for the state of the edge apparatus Ei recognized (predicted) by the management apparatus 101, the processing completion rate and the slope at the time t are corrected, resulting in a graph 903.

The output unit 805 outputs the prediction result obtained by the state prediction unit 804. Examples of the output format from the output unit 805 include transmission to another computer through the communication I/F, display on a display, print output to a printer, storage in a storage device such as a memory and a disc, and the like.

For example, the output unit 805 may display the predicted processing completion time of the edge apparatus Ei to the client apparatus 102. In this event, the output unit 805 may display the current processing completion rate of the edge apparatus Ei together with the remaining time until the predicted processing completion time.

In some cases, processing is being executed by a plurality of edge apparatuses in response to a processing execution request from the client apparatus 102. In this case, the output unit 805 displays the latest predicted processing completion time among the predicted processing completion times of the plurality of edge apparatuses as the predicted processing completion time of the entire processing to the client apparatus 102. The output unit 805 may display the predicted processing completion time of each of the plurality of edge apparatuses.

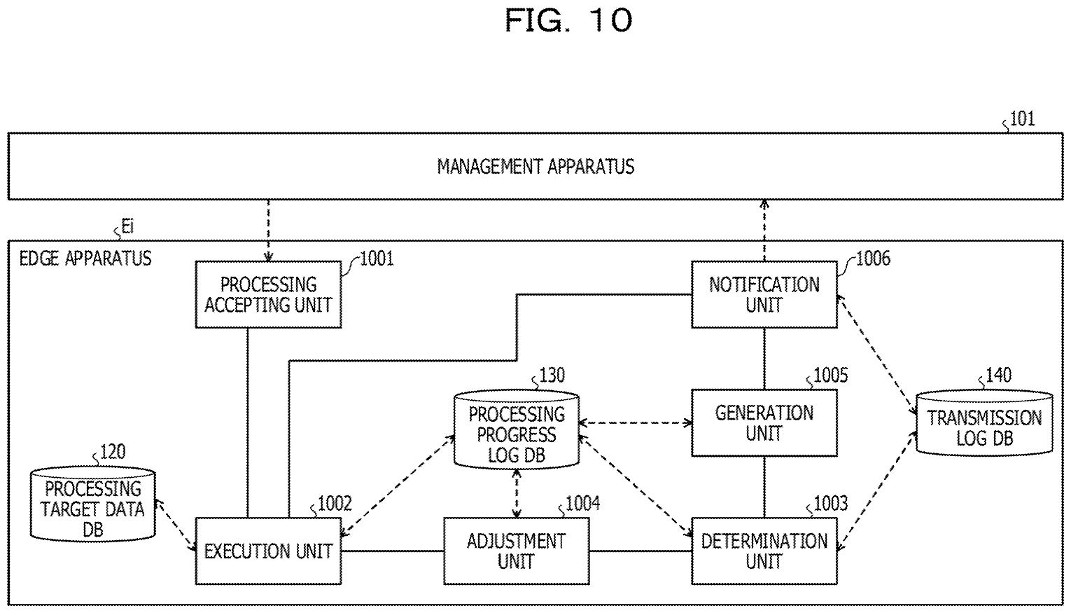

Next, a functional configuration example of the edge apparatus Ei will be described. FIG. 10 is a block diagram illustrating a functional configuration example of the edge apparatus Ei. In FIG. 10, the edge apparatus Ei includes a processing accepting unit 1001, an execution unit 1002, a determination unit 1003, an adjustment unit 1004, a generation unit 1005, and a notification unit 1006. For example, the processing accepting unit 1001 to the notification unit 1006 realize their functions by causing the CPU 301 to execute a program stored in a storage device such as the memory 302 and the disc 304 illustrated in FIG. 3, or through the communication I/F 305. The processing result obtained by each functional unit is stored, for example, in the storage device such as the memory 302 and the disc 304.

The processing accepting unit 1001 accepts an instruction to execute the processing Pi. The instruction to execute the processing Pi includes, for example, information that specifies data to be processed and the processing contents of the processing Pi. For example, the processing accepting unit 1001 receives the instruction to execute the processing Pi from the management apparatus 101, and thus accepts the received instruction to execute the processing Pi.

The execution unit 1002 executes the processing Pi in response to the instruction to execute the processing Pi. For example, the execution unit 1002 acquires data to be processed that is specified from the instruction to execute the processing Pi from the processing target data DB 120 (see FIG. 1). Then, the execution unit 1002 starts executing the processing Pi on the acquired data to be processed. The processing content of the processing Pi is specified from the instruction to execute the processing Pi.

The execution unit 1002 records information indicating the progress of the processing Pi. For example, the execution unit 1002 records a processing progress log indicating the progress of the processing Pi at a predetermined timing from the start of the execution of the processing Pi until the execution of the processing Pi is completed, in the processing progress log DB 130 illustrated in FIG. 5.

The processing progress log includes, for example, time t and processing completion rate. The processing completion rate indicates a completion rate of the processing Pi at the time t (unit: [%]). The processing completion rate is measured, for example, by determining the ratio of processing (for example, processes) that is currently completed to the entire processing Pi (for example, a plurality of processes).

The timing for recording the processing progress log may be arbitrarily set. For example, the execution unit 1002 may record the processing progress log indicating the progress of the processing PI every time processing is executed on a certain amount of data (for example, 1 MB, 10 files, or the like) or for a certain period of time (for example, several minutes).

The determination unit 1003 determines whether to notify the management apparatus 101 of correction information about the state of the own apparatus based on whether or not the error related to the state of the own apparatus recognized by the management apparatus 101 exceeds the threshold Th. For example, the determination unit 1003 determines whether or not a difference between the actual state of the own apparatus (the state of the own apparatus recognized by the edge apparatus Ei) and the state of the edge apparatus Ei recognized by the management apparatus 101 exceeds a threshold Th.

When the difference exceeds the threshold Th, the determination unit 1003 determines to notify the management apparatus 101 of the correction information about the state of the own apparatus. On the other hand, when the difference is equal to or less than the threshold Th, the determination unit 1003 determines not to notify the management apparatus 101 of the correction information about the state of the own apparatus.

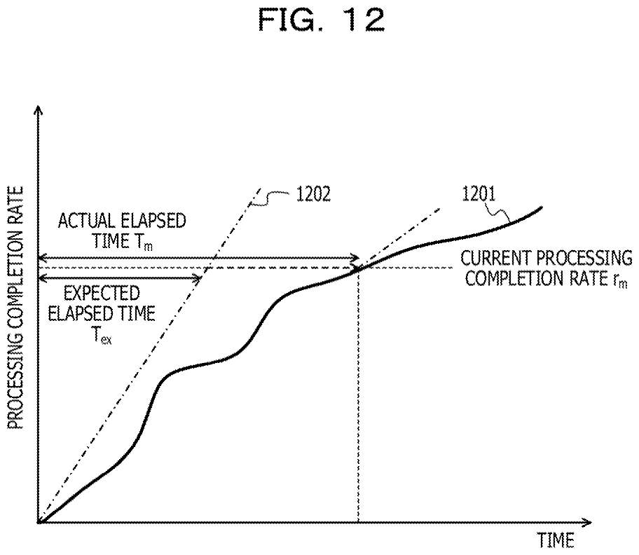

The state of the edge apparatus Ei may be represented by, for example, the elapsed time until the current completion rate of the processing Pi (processing completion rate) is reached, that is, the elapsed time from the start of the processing. However, the state of the edge apparatus Ei may be represented by the completion rate of the processing Pi. The specific processing content of the determination unit 1003 will be described later with reference to FIG. 12.

The adjustment unit 1004 adjusts the threshold Th according to the completion rate of the processing Pi. The threshold Th is a threshold for an error related to the state of the edge apparatus Ei recognized by the management apparatus 101, and is the value used to determine whether to notify the management apparatus 101 of correction information about the state of the edge apparatus Ei. For example, when the state of the edge apparatus Ei is represented by the elapsed time until the current processing completion rate is reached, the threshold Th is the threshold for an error between the elapsed time recognized by the edge apparatus Ei and the elapsed time recognized by the management apparatus 101.

For example, the adjustment unit 1004 may make an adjustment such that the higher the completion rate of the processing Pi, the smaller the threshold Th. Once the completion rate of the processing Pi has become equal to or more than a predetermined value, the adjustment unit 1004 may make an adjustment such that the higher the completion rate of the processing Pi, the smaller the threshold Th.

For example, the adjustment unit 1004 may adjust the threshold Th according to the completion rate of the processing Pi based on a preset threshold function. The threshold function is a function that defines a correspondence between the completion rate of the processing Pi and the threshold Th. Information that specifies the threshold function is stored, for example, in a storage device such as the memory 302 and the disc 304.

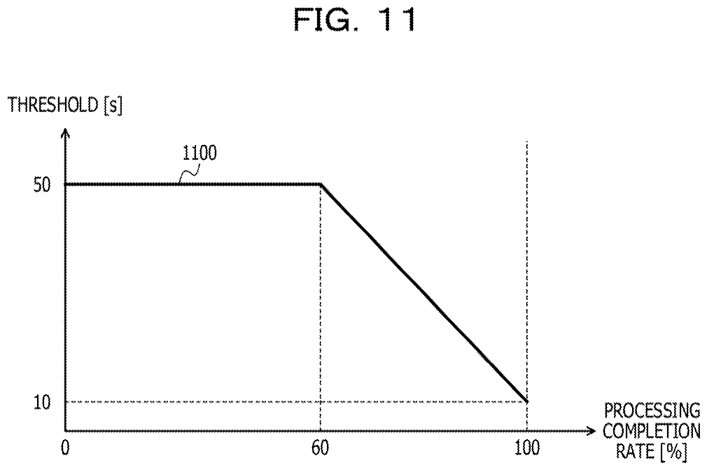

An example of the threshold function will be described with reference to FIG. 11. FIG. 11 is an explanatory diagram illustrating an example of the threshold function. In FIG. 11, a threshold function 1100 is a function that defines a correspondence between a processing completion rate (completion rate of processing Pi) and a threshold Th. The unit of the threshold Th is [s]. In the threshold function 1100, the threshold Th takes a fixed value (50 [s]) until the processing completion rate reaches a predetermined value (60[%]) or more. Once the processing completion rate has reached the predetermined value or more, the threshold Th is gradually decreased as the processing completion rate is increased.

According to the threshold function 1100, the adjustment unit 1004 may set the threshold Th to the fixed value (50 [s]) until the processing completion rate reaches 60[%]. Once the processing completion rate has reached 60[%] or more, the adjustment unit 1004 may adjust the threshold Th to get gradually decreased as the processing completion rate is increased.

Returning to the description of FIG. 10, the generation unit 1005 generates correction information about the state of the edge apparatus E. The correction information includes, for example, information that specifies the completion rate of the processing Pi at a predetermined time point and the amount of change per unit time of the completion rate of the processing Pi after the predetermined time point. When the predicted value of the completion rate of the processing Pi is modeled by a linear expression, the amount of change per unit time of the completion rate of the processing Pi after the predetermined time point may be expressed by a slope. The correction information is generated, for example, when the determination unit 1003 determines to notify the management apparatus 101 of the correction information.

For example, the generation unit 1005 refers to the processing progress log DB 130 illustrated in FIG. 5 to calculate the slope of the processing completion rate (completion rate of the processing PI) after the time t. The time t is, for example, the latest time in the processing progress log DB 130. To be more specific, for example, the generation unit 1005 calculates the slope of the processing completion rate after the time t based on the processing completion rate at the time t and a processing completion rate at any time before the time t.

In this event, the generation unit 1005 may determine a method for calculating the slope of the processing completion rate after the time t according to the completion rate of the processing Pi at the time t. For example, when the completion rate of the processing Pi at the time t is equal to or less than a predetermined value K, the generation unit 1005 determines to use a first calculation method. On the other hand, when the completion rate of the processing Pi at the time t exceeds the predetermined value K, the generation unit 1005 determines to use a second calculation method.

The predetermined value K may be arbitrarily set, and is set to a value of about 70 to 80[%], for example. That is, the generation unit 1005 changes the method for calculating the slope of the processing completion rate after the time t from the first calculation method to the second calculation method in response to the processing completion rate at the time t exceeding the predetermined value K.

The first calculation method is a method of calculating the slope of the processing completion rate after the time t based on the processing completion rate at the time t (predetermined time point) and the elapsed time from the start of the processing. The second calculation method is a method of calculating the slope of the processing completion rate after the time t based on the processing completion rate at the time t and a processing completion rate at a time t′ that is a predetermined time before the time t.

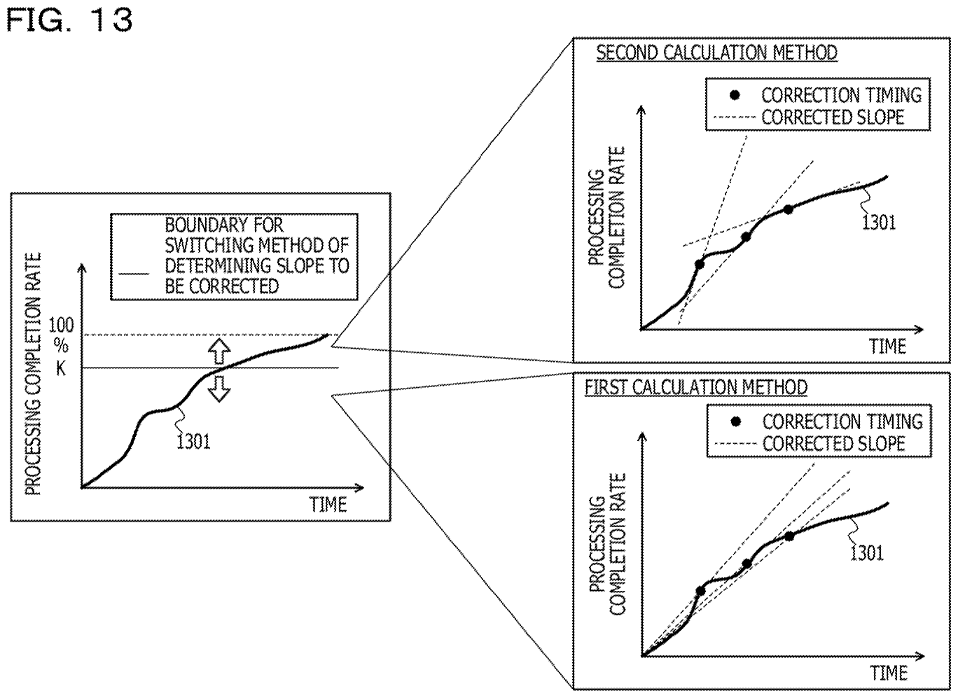

The predetermined time may be arbitrarily set. For example, the time t′ may be a time about several minutes before the time t, or may be a time just before the time t (latest time) in the processing progress log DB 130. The first calculation method and the second calculation method will be described later with reference to FIG. 13.

The notification unit 1006 notifies the correction information generated by the generation unit 1005. For example, when it is determined by the determination unit 1003 that the correction information about the state of the own apparatus is to be notified to the management apparatus 101, the notification unit 1006 notifies the management apparatus 101 of the correction information generated by the generation unit 1005.

When the execution of the processing Pi Is completed, the notification unit 1006 transmits a processing completion notification to the management apparatus 101. The processing completion notification is information indicating that the execution of the processing Pi is completed. The processing results of the processing Pi are collectively transmitted from the edge apparatus Ei to the management apparatus 101, for example, as the execution of the processing Pi is completed.

When information (correction information or processing completion notification) is transmitted from the edge apparatus Ei to the management apparatus 101, a log related to the transmitted information is recorded, for example, in the transmission log DB 140 illustrated in FIG. 1.

Next, specific processing contents of the determination unit 1003 will be described with reference to FIG. 12. FIG. 12 is an explanatory diagram illustrating an example of an error related to the state of the edge apparatus Ei. In FIG. 12, a graph 1201 represents an actual state of the edge apparatus Ei. A graph 1202 represents the state of the edge apparatus Ei recognized (predicted) by the management apparatus 101.

First, the determination unit 1003 refers to the processing progress log DB 130 to acquire a current processing completion rate rₘ and an actual elapsed time Tₘ. The current processing completion rate rₘ is a processing completion rate at the latest time in the processing progress log DB 130. The actual elapsed time Tₘ is the time from the processing start time of the processing Pi to the current time. The current time is the latest time in the processing progress log DB 130.

Next, the determination unit 1003 refers to the transmission log DB 140 to acquire the correction information last transmitted to the management apparatus 101. Then, the determination unit 1003 specifies a time tⱼ, a processing completion rate rⱼ at the time tⱼ, and a slope aⱼ after the time tⱼ, which are included in the acquired last correction information. The slope aⱼ corresponds to the slope of the graph 1202.

Next, the determination unit 1003 calculates an expected elapsed time Tₑₓ recognized by the management apparatus 101. The expected elapsed time Tₑₓ is a time recognized by the management apparatus 101 as an elapsed time until the current processing completion rate rₘ is reached. For example, the determination unit 1003 may calculate the expected elapsed time Tₑₓ using the following equation (1). t₀ is the process start time of the processing Pi.

Tₑₓ=(rₘ−rⱼ)/aⱼ+(tⱼ−t₀) (1)

Then, the determination unit 1003 determines whether or not a difference between the calculated expected elapsed time Tₑₓ and the actual elapsed time Tₘ (|Tₑₓ−Tₘ|) exceeds a threshold Th. The threshold Th is adjusted by the adjustment unit 1004 according to the current processing completion rate rₘ. When the difference exceeds the threshold Th, the determination unit 1003 determines to notify the management apparatus 101 of correction information. On the other hand, when the difference is equal to or less than the threshold Th, the determination unit 1003 determines not to notify the management apparatus 101 of the correction information.

As an example, the processing start time to of the processing Pi is “10/17/2018 10:29:03”, the current processing completion rate rₘ is “56.0 [%]”, and the threshold Th corresponding to the current processing completion rate rₘ is “50 [s]”. In this case, when the current time is “10/17/2018 11:45:10”, the actual elapsed time Tₘ is “4567 [s]”.

The correction information last transmitted to the management apparatus 101 is the correction information 400 illustrated in FIG. 4. In this case, the expected elapsed time Tₑₓ is “Tₑₓ=(56.0−55.4)/0.01240+4467=4515 [s]”. “4467” corresponds to (tⱼ−t₀). The difference between the expected elapsed time Tₑₓ and the actual elapsed time Tₘ (|Tₑ−Tₘ|) is “52 [s]”. In this case, since the difference exceeds the threshold Th, the determination unit 1003 determines to notify the management apparatus 101 of the correction information.

Next, the first calculation method and the second calculation method for calculating the slope of the processing completion rate after the time t will be described with reference to FIG. 13. FIG. 13 is an explanatory diagram illustrating an example of a method of calculating a slope. In FIG. 13, a graph 1301 represents an actual state of the edge apparatus Ei. The method for calculating the slope of the processing completion rate after the time t is switched from the first calculation method to the second calculation method according to whether or not the processing completion rate at the time t exceeds the predetermined value K.

In the first calculation method, the generation unit 1005 calculates the slope of the processing completion rate after the time t by, for example, dividing the processing completion rate at the time t by the elapsed time from the start of the processing at the time t. According to the first calculation method, high-speed processing and low-speed processing are averaged to enable stable prediction independent of the situation at the time of correction. Therefore, it may be said that the first calculation method is suitable for a long-term prediction, that is, a situation where it takes time to complete the processing. For this reason, the first calculation method is applied when the processing completion rate is equal to or less than the predetermined value K.

In the second calculation method, the generation unit 1005 calculates the slope of the processing completion rate after the time t based on the processing completion rate at the time t and the processing completion rate at a time t that is a predetermined time before the time t. That is, the correction is performed with the slope in the actual state at the time of correction. According to the second calculation method, it is possible to make a prediction that follows a local change in the state of the edge apparatus Ei. Therefore, it may be said that the second calculation method is suitable for short-term prediction. For this reason, the second calculation method is applied when the processing completion rate exceeds the predetermined value K.

As an example, the predetermined value K is “80[%]” and the processing completion rate at the time t is “56.0[%]”. In this case, since the processing completion rate is equal to or less than the predetermined value K, the slope of the processing completion rate after the time t is calculated using the first calculation method. If the elapsed time from the start of the processing is “4567 [s]”, the slope of the processing completion rate after the current time t is “0.01226[%/s]”.

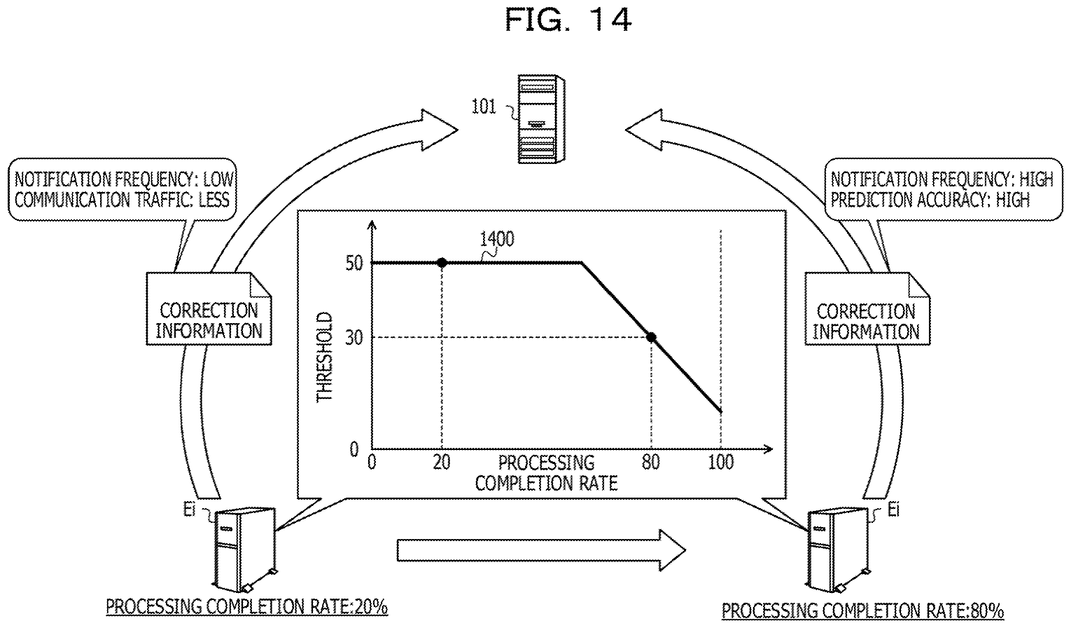

Next, an example of adjusting the threshold Th according to the processing completion rate (completion rate of the processing Pi) in the edge apparatus Ei will be described with reference to FIG. 14. FIG. 14 is an explanatory diagram illustrating an example of adjusting the threshold Th. FIG. 14 illustrates an edge apparatus Ei when the processing completion rate is “20[%]” and an edge apparatus Ei when the processing completion rate is “80[%]”. It is assumed that the edge apparatus Ei adjusts the threshold Th used to determine whether to notify the management apparatus 101 of correction information about the state of the edge apparatus Ei based on the threshold function 1400.

When the processing completion rate is “20[%]”, the edge apparatus Ei sets the threshold Th to “Th=50” corresponding to the processing completion rate “20[%]” based on the threshold function 1400. On the other hand, when the processing completion rate is “80[%]”, the edge apparatus Ei sets the threshold Th to “Th=30” corresponding to the processing completion rate “80[%]” based on the threshold function 1400.

In this way, the edge apparatus Ei controls the notification frequency of the correction information about the state of the edge apparatus Ri by adjusting the threshold Th according to the processing completion rate. When the threshold Th is “50”, the notification frequency of the correction information is reduced compared with the case where the threshold Th is “30”, thus making it possible to reduce an increase in communication traffic. On the other hand, when the threshold Th is “30”, the notification frequency of the correction information is increased compared with the case where the threshold Th is “50”, thus making it possible to improve the prediction accuracy.

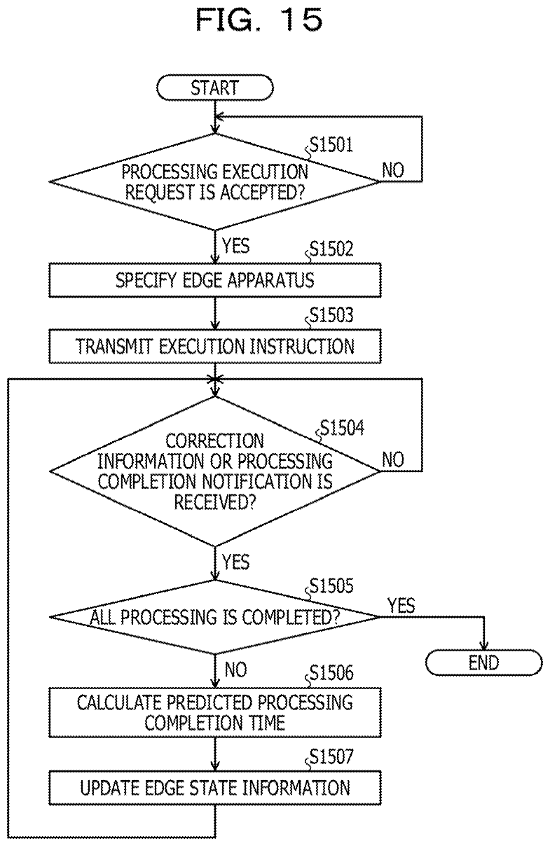

Next, a state management processing procedure of the management apparatus 101 will be described with reference to FIG. 15. FIG. 15 is a flowchart illustrating an example of the state management processing procedure of the management apparatus 101. In the flowchart illustrated in FIG. 15, the management apparatus 101 first determines whether or not a processing execution request has been received (Step S1501). The management apparatus 101 waits to receive the processing execution request (Step S1501: No).

When having received the processing execution request (Step S1501: Yes), the management apparatus 101 refers to the data storage information DB 150 illustrated to specify the edge apparatus Ei that stores data to enable execution of processing specified from the processing execution request (Step S1502).

Then, the management apparatus 101 transmits an instruction to execute the processing Pi specified from the processing execution request to the specified edge apparatus Ei (Step S1503). Then, the management apparatus 101 determines whether or not correction information about the state of the edge apparatus Ei or a processing completion notification has been received from the edge apparatus Ei (Step S1504).

The management apparatus 101 waits to receive the correction information or the processing completion notification (Step S1504: No). When having received the correction information or the process completion notification (Step S1504: Yes), the management apparatus 101 determines whether or not all the processing is completed (Step S1505).

The completion of all the processing indicates that all the processing Pi of each edge apparatus Ei that has transmitted the execution instruction is completed. For example, when an execution instruction is transmitted to a plurality of edge apparatuses, it is determined that all the processing is completed when all the processing in each of the plurality of edge apparatuses is completed.

When all the processing is not completed (Step S1505: No), the management apparatus 101 calculates a predicted processing completion time for the edge apparatus Ei based on the received correction information or processing completion notification (Step S1506). When the processing completion notification is received, the predicted processing completion time for the edge apparatus Ei is the time t included in the processing completion notification.

Then, the management apparatus 101 updates the edge state information of the edge apparatus Ei in the edge state DB 160 using the predicted processing completion time calculated (Step S1507), and returns to Step S1504. When there is no corresponding record in the edge state DB 160, a new record corresponding to the edge apparatus Ei is created.

In Step S1505, when all the processing is completed (Step S1505: Yes), the management apparatus 101 terminates the series of processing according to this flowchart.

Accordingly, the state of the edge apparatus Ei recognized by the management apparatus 101 may be updated based on the correction information about the state of the edge apparatus Ei notified from the edge apparatus Ei. Therefore, it is possible to display the state of each edge apparatus Ei (for example, the predicted processing completion time of each edge apparatus Ei), the predicted processing completion time of all the processing, and the like to the client apparatus 102.

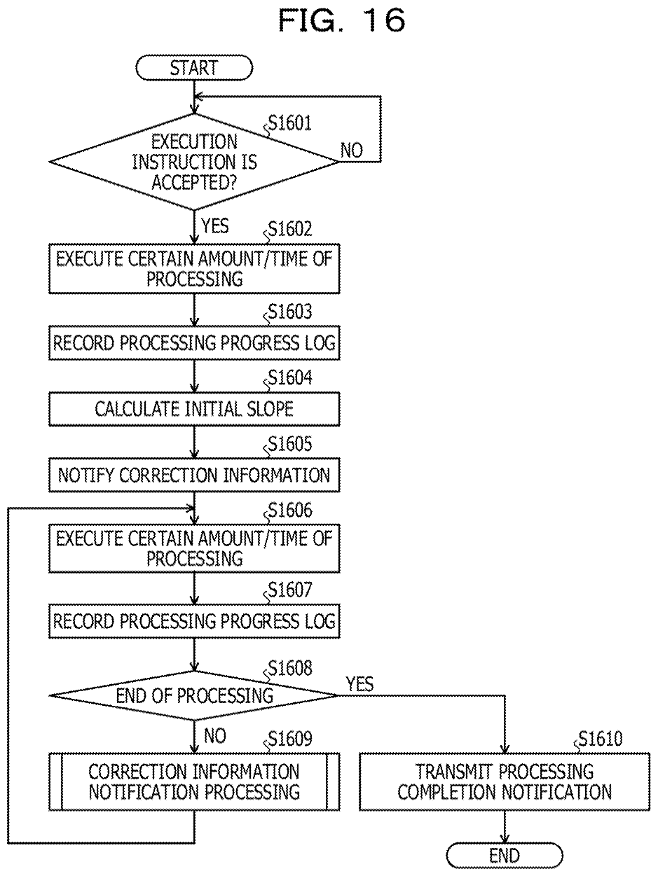

Next, an execution processing procedure of the edge apparatus Ei will be described with reference to FIG. 16. FIG. 16 is a flowchart illustrating an example of the execution processing procedure of the edge apparatus Ei. In the flowchart illustrated in FIG. 16, the edge apparatus Ei first determines whether or not an instruction to execute processing Pi has been received from the management apparatus 101 (Step S1601).

The edge apparatus Ei waits to receive the instruction to execute the processing Pi (Step S1601: No). When having received the instruction to execute the processing Pi (Step S1601: Yes), the edge apparatus Ei executes a certain amount/time of the processing Pi (Step S1602).

Such a certain amount/time of processing is processing for a certain amount of data (for example, 1 MB, 10 files, or the like) or processing for a certain amount of time (for example, several minutes).

Next, the edge apparatus Ei records a processing progress log indicating the progress of the processing Pi in the processing progress log DB 130 (Step S1603). Then, the edge apparatus Ei calculates an initial slope by dividing the processing completion rate at the current time t by the elapsed time from the processing start time of the processing Pi (Step S1604).

Thereafter, the edge apparatus Ei notifies the management apparatus 101 of correction information (initial notification) including the processing completion rate and the initial slope at the current time t (Step S1605). The correction information (initial notification) may include, for example, the processing start time of the processing Pi. Next, the edge apparatus Ei executes a certain amount/time of processing for the processing Pi (Step S1606). Then, the edge apparatus Ei records a processing progress log in the processing progress log DB 130 (Step S1607).

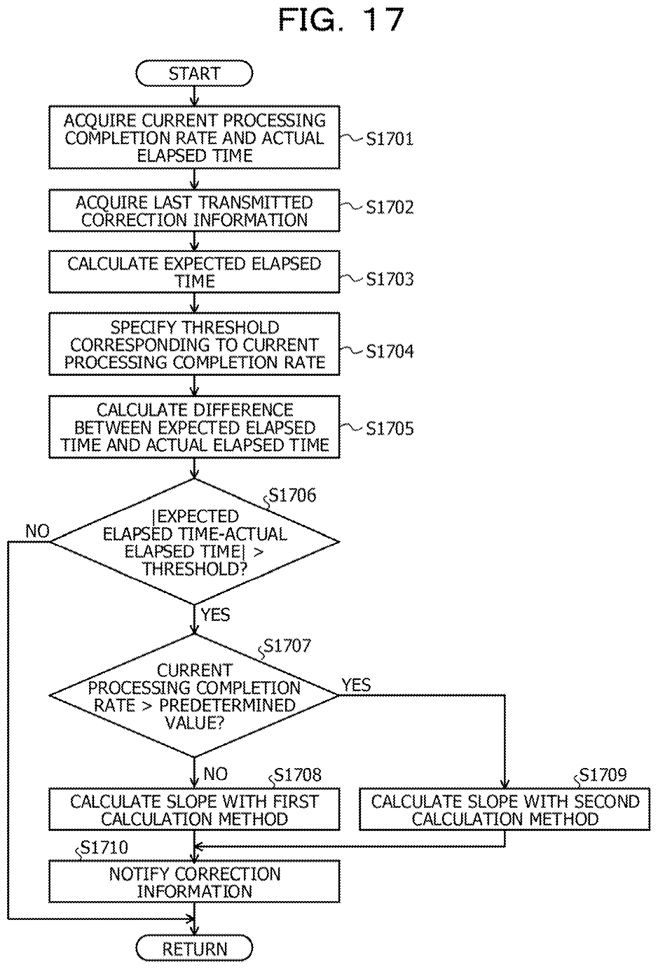

Next, the edge apparatus Ei determines whether or not the processing Pi is completed (Step S1608). When the processing Pi is not completed (Step S1608: No), the edge apparatus Ei executes correction information notification processing (Step S1609) and returns to Step S1606. A specific processing procedure of the correction information notification processing will be described later with reference to FIG. 17.

In Step S1608, when the processing Pi is completed (Step S1608: Yes), the edge apparatus Ei transmits a processing completion notification to the management apparatus 101 (Step S1610), and terminates the series of processing according to this flowchart. Thus, the processing Pi instructed to be executed from the management apparatus 101 may be executed.

Next, a specific processing procedure of the correction information notification processing in Step S1609 will be described with reference to FIG. 17. FIG. 17 is a flowchart illustrating an example of the specific processing procedure of correction information notification processing. In the flowchart illustrated in FIG. 17, the edge apparatus Ei first refers to the processing progress log DB 130 to acquire a current processing completion rate rₘ and an actual elapsed time Tₘ (Step S1701).

Next, the edge apparatus Ei refers to the transmission log DB 140 to acquire the correction information last transmitted to the management apparatus 101 (Step S1702). Then, the edge apparatus Ei calculates an expected elapsed time Tₑₓ recognized by the management apparatus 101 based on the time tⱼ, the processing completion rate rⱼ at the time tⱼ, and the slope aⱼ after the time tⱼ included in the acquired last correction information (Step S1703).

Next, the edge apparatus Ei specifies a threshold Th corresponding to the current processing completion rate rₘ based on a threshold function (for example, the threshold function 1100 illustrated in FIG. 11) (Step S1704). Then, the edge apparatus Ei calculates a difference between the calculated expected elapsed time Tₑₓ and the actual elapsed time Tₘ (Step S1705).

Thereafter, the edge apparatus Ei determines whether or not the calculated difference exceeds the specified threshold Th (Step S1706). When the calculated difference is equal to or less than the threshold Th (Step S1706: No), the edge apparatus Ei returns to the step of calling up the correction information notification processing. In this case, the correction information is not notified to the management apparatus 101.

On the other hand, when the calculated difference exceeds the threshold Th (Step S1706: Yes), the edge apparatus Ei determines whether or not the current processing completion rate rₘ exceeds a predetermined value K (Step S1707). When the current processing completion rate rₘ is equal to or less than the predetermined value K (Step S1707: No), the edge apparatus Ei uses the first calculation method to calculate the slope of the processing completion rate after the current time t (Step S1708) and proceeds to Step S1710. The current time t is the time t corresponding to the current processing completion rate rₘ.

On the other hand, when the current processing completion rate rₘ exceeds the predetermined value K (Step S1707: Yes), the edge apparatus Ei uses the second calculation method to calculate the slope of the processing completion rate after the current time t (Step S1709). Then, the edge apparatus Ei notifies the management apparatus 101 of correction information including the processing completion rate rₘ at the current time t and the slope of the calculated processing completion rate after the current time t (Step S1710) and returns to the step of calling up the correction information notification processing.

Thus, when the error related to the state of the edge apparatus Ei recognized by the management apparatus 101 exceeds the threshold Th, the correction information about the state of the edge apparatus Ei may be notified to the management apparatus 101. The threshold Th may be adjusted according to the current processing completion rate rₘ. The method for calculating the slope of the processing completion rate after the current time t may be switched according to the current processing completion rate rₘ.

Although the threshold Th is adjusted according to the processing completion rate in the above description, the embodiments are not limited thereto. For example, the threshold Th may be a predetermined fixed value.

As described above, the edge apparatus Ei according to Embodiment 1 may adjust the threshold Th of the error related to the state of the own apparatus recognized by the management apparatus 101 according to the completion rate of the processing Pi, and may determine to notify the management apparatus 101 of correction information about the state of the own apparatus, when the error exceeds the threshold Th.

Accordingly, the frequency of notifying the correction information about the state of the edge apparatus Ei may be controlled to realize an effective notification frequency for the situation.

The edge apparatus Ei may also make an adjustment such that the higher the completion rate of the processing Pi, the smaller the threshold Th. As a result, the prediction accuracy may be improved by suppressing the frequency of notifying the management apparatus 101 of the correction information from the start of the processing to about the intermediate point to reduce an increase in communication traffic, and then increasing the frequency of notifying the management apparatus 101 of the correction information when the processing comes close to its completion.

Upon calculation of the slope of the completion rate of the processing PI after the time t, the edge apparatus Ei may switch the method of calculating the slope according to the completion rate of the processing Pi at the time t. Thus, upon prediction of the completion time of the processing Pi, it is possible to perform predictions with different properties depending on the situation.

For example, the edge apparatus Ei may calculate the slope of the completion rate of the processing Pi after the time t, based on the completion rate of the processing PI and the elapsed time from the start of the processing at the time t when the completion rate of the processing Pi at the time t is equal to or less than the predetermined value K. As a result, high-speed processing and low-speed processing are averaged to enable stable prediction independent of the situation at the time of correction.

When the completion rate of the processing Pi at the time t exceeds the predetermined value K, the edge apparatus Ei may calculate the slope of the completion rate of processing Pi after the time t based on the completion rate of the processing Pi at the time t and the completion rate of the processing Pi at the time t′ that is a predetermined time before the time t. As a result, even when the state of the edge apparatus Ei locally changes, it is possible to make a prediction that follows such a change.

For these reasons, the information processing system 100 according to Embodiment 1 may appropriately reduce an increase in communication traffic required for state notification while ensuring the prediction accuracy required by the user by realizing an effective notification frequency for the situation.

Next, an information processing system 100 according to Embodiment 2 will be described. Note that the same parts as those described in Embodiment 1 are denoted by the same reference numerals, and illustration and description thereof are omitted. In the information processing system 100, when there are many edge apparatuses that execute processing instructed by the management apparatus 101 in response to a processing execution request from the client apparatus 102 or the like, a lot of correction information is transmitted and received within the information processing system 100. For example, when there are hundreds of edge apparatuses, communication traffic that is several hundred times that of a single edge apparatus occurs.

On the other hand, information desired by the user is often information on when the processing on all the edge apparatuses is completed, rather than information on when the processing on each of the edge apparatuses is completed. Although differences in throughput and processing performance between the edge apparatuses also lead to a difference in processing completion time, the edge apparatus that immediately completes the processing among the plurality of edge apparatuses does not affect the completion time of the entire processing.

Therefore, in Embodiment 2, an increase in communication traffic is reduced by not reducing the threshold Th to suppress the correction information notification frequency even when the processing comes to its completion for the edge apparatus expected to complete the processing immediately among the plurality of edge apparatuses.

A functional configuration example of the management apparatus 101 according to Embodiment 2 will be described. In the following description, a plurality of edge apparatuses that execute processing instructed to be executed by the management apparatus 101 in response to a processing execution request may be referred to as a “plurality of edge apparatuses E”, and the processing instructed to be executed by the management apparatus 101 may be referred to as “processing P”.

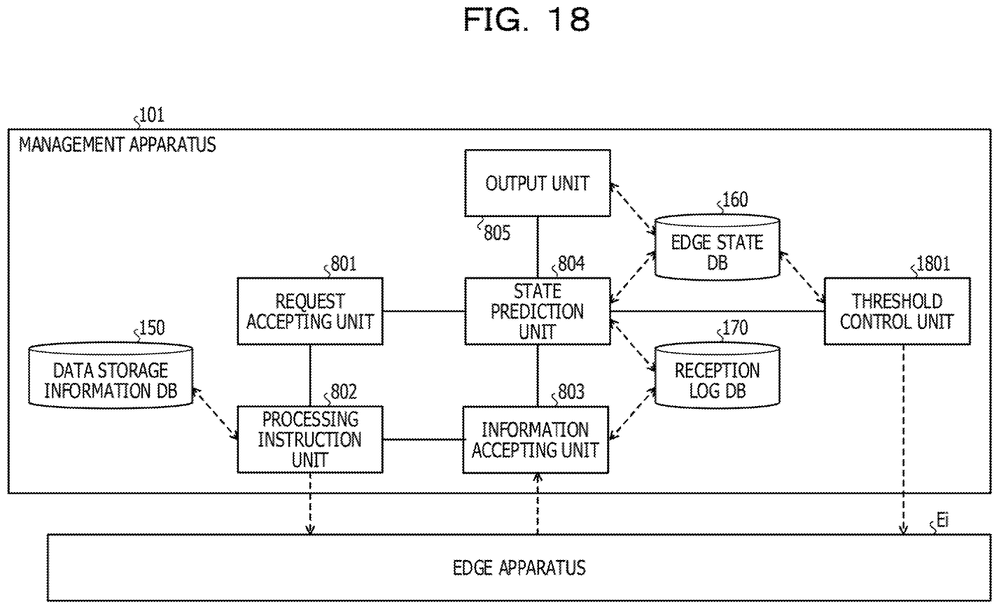

FIG. 18 is a block diagram illustrating a functional configuration example of the management apparatus 101 according to Embodiment 2. In FIG. 18, the management apparatus 101 includes a request accepting unit 801, a processing instruction unit 802, an information accepting unit 803, a state prediction unit 804, an output unit 805, and a threshold control unit 1801. For example, the request accepting unit 801 to the output unit 805 and the threshold control unit 1801 realize their functions by causing a CPU to execute a program stored in a storage device such as a memory or a disc in the management apparatus 101, or through a communication I/F. The processing results from the respective functional units are stored, for example, in the storage device such as the memory or disc.

The threshold control unit 1801 determines a threshold function for each edge apparatus E based on the predicted processing completion time of each of the plurality of edge apparatuses E. The predicted processing completion time is the completion time of the processing P in each edge apparatus E calculated (predicted) by the state prediction unit 804. The threshold function is a function that defines a correspondence between the completion rate of the processing P in the edge apparatus E and the threshold Th.

For example, the threshold control unit 1801 specifies one or more edge apparatuses E having a relatively late predicted processing completion time among the plurality of edge apparatuses E. Then, as for the specified edge apparatus E, the threshold control unit 1801 may determine a threshold function that defines a correspondence relationship that the higher the completion rate of the processing P (processing completion rate), the smaller the threshold Th. As for the edge apparatuses E other than the specified edge apparatus E among the plurality of edge apparatuses E, the threshold control unit 1801 may determine a threshold function having a fixed threshold Th for the completion rate of the processing P.

To be more specific, for example, the edge apparatus E that differs in predicted processing completion time from the edge apparatus E having the latest predicted processing completion time is within a predetermined time (for example, within 10 minutes) is specified from among the plurality of edge apparatuses E. Then, the threshold control unit 1801 determines a threshold function A for the specified edge apparatus E. The threshold control unit 1801 also determines a threshold function B for the edge apparatuses E other than the specified edge apparatus E among the plurality of edge apparatuses E.

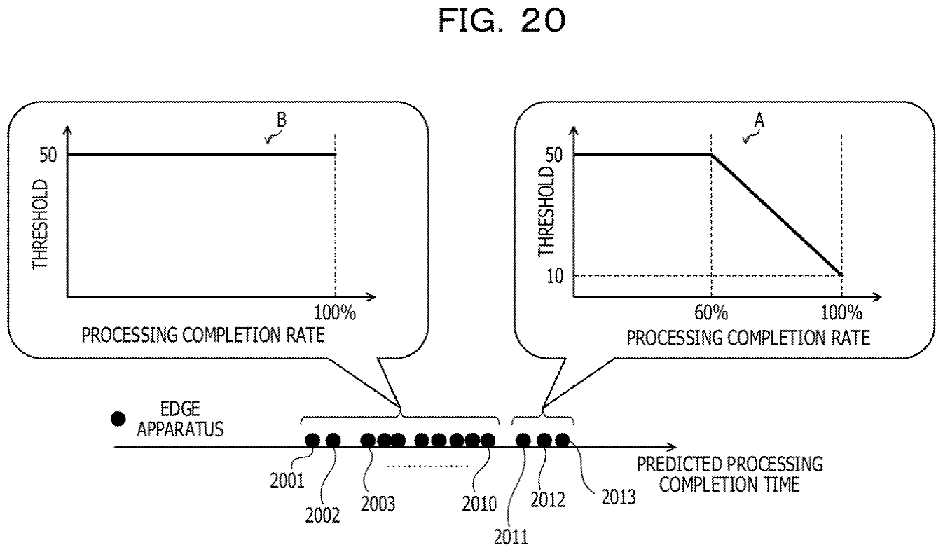

The threshold functions A and B are functions that define a correspondence between the completion rate of the processing P and the threshold Th, and differ from each other in function shape. The threshold function A is, for example, a function that defines a correspondence relationship that the threshold Th is fixed until the completion rate of the processing P reaches a predetermined value and, once the completion rate of the processing P has reached the predetermined value or more, the higher the completion rate of the processing P, the smaller the threshold Th. The threshold function B is a function that defines a correspondence relationship that the threshold Th is fixed regardless of the completion rate of the processing P. Specific examples of the threshold functions A and B will be described later with reference to FIG. 20.

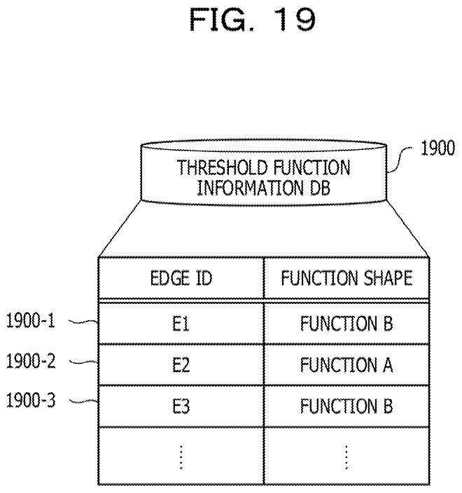

The determination result obtained is stored in, for example, a threshold function information DB 1900 as illustrated in FIG. 19. The contents stored in the threshold function information DB 1900 will be described.

FIG. 19 is an explanatory diagram illustrating an example of the contents stored in the threshold function information DB 1900. In FIG. 19, the threshold function information DB 1900 has fields of edge ID and function shape, and stores threshold function information (for example, threshold function information 1900-1 to 1900-3) as records by setting information in each field.

The edge ID is an identifier that uniquely identifies the edge apparatus Ei. The function shape is information that specifies a threshold function. The function name of the threshold function is set as the function shape. For example, the threshold function information 1900-1 indicates the function shape “function B” of the edge apparatus E1.

In the function shape field, a shape parameter of a piece-wise linear function may be set. As the shape parameter, for example, the threshold Th when the processing completion rate is 0% and 100% and the processing completion rate when the threshold Th starts to decrease are set.

The threshold control unit 1801 notifies each edge apparatus E of information that specifies the determined threshold function for each edge apparatus E. In this case, each information processing apparatus adjusts the threshold Th according to the threshold function specified from the notified information. The information that specifies the threshold function may be a function name or a shape parameter of a piece-wise linear function.

It is assumed, for example, that each edge apparatus E holds a plurality of types of threshold functions (for example, threshold functions A and B) in advance. In this case, the information that specifies the threshold function may be a function name. Each information processing apparatus selects a threshold function specified from the notified function name from among the plurality of types of threshold functions held in advance, and adjusts the threshold Th according to the selected threshold function.

On the other hand, when each edge apparatus E does not hold the plurality of types of threshold functions, the information that specifies the threshold function is a shape parameter of a piece-wise linear function. In this case, each information processing apparatus adjusts the threshold Th according to the threshold function specified from the notified shape parameter.

An example of determining the threshold function will be described with reference to FIG. 20. FIG. 20 is an explanatory diagram illustrating an example of determining a threshold function. In FIG. 20, marks 2001 to 2013 on the time axis indicate a predicted processing completion time of each of the plurality of edge apparatuses E. Among the plurality of edge apparatuses E, the threshold function A is determined for the top three edge apparatuses E (corresponding to the marks 2011 to 2013) having the late predicted processing completion time. The threshold function B is determined for the other edge apparatuses E (corresponding to the marks 2001 to 2010) among the plurality of edge apparatuses E.

According to the threshold function A, the threshold Th may be set to a fixed value (50 [s]) until the processing completion rate reaches 60[%], and, once the processing completion rate reaches 60[%] or more, the threshold Th may be adjusted to be gradually decreased as the processing completion rate is increased. According to the threshold function B, the threshold Th may be set to a fixed value (50 [s]) regardless of the processing completion rate.

The threshold function A is represented by a shape parameter “(0, 50) (60, 50) (100, 10)”. The threshold function B is represented by a shape parameter “(0, 50) (100, 50)”.

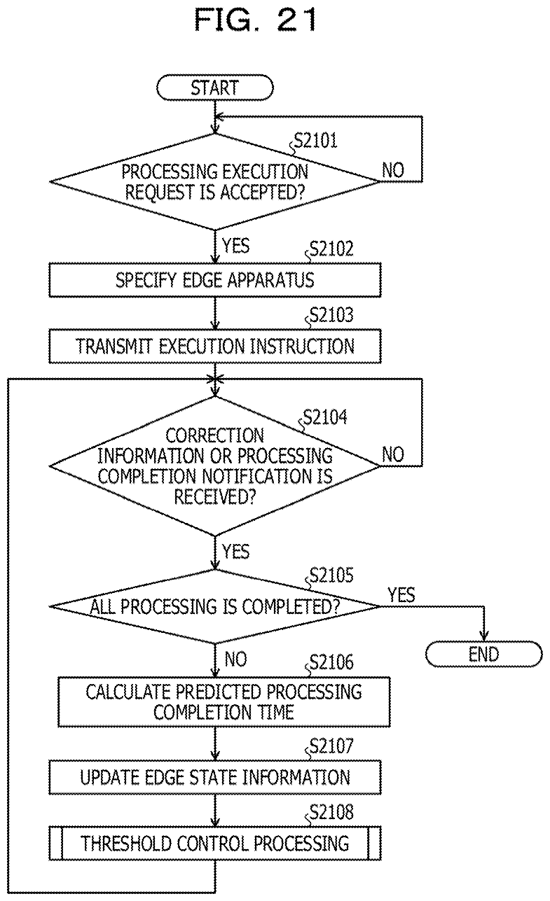

Next, a state management processing procedure of the management apparatus 101 according to Embodiment 2 will be described with reference to FIG. 21. FIG. 21 is a flowchart illustrating an example of the state management processing procedure of the management apparatus 101. In the flowchart illustrated in FIG. 21, the management apparatus 101 first determines whether or not a processing execution request has been received (Step S2101). The management apparatus 101 waits to receive the processing execution request (Step S2101: No).

When having received the processing execution request (Step S2101: Yes), the management apparatus 101 refers to the data storage information DB 150 to specify the edge apparatus E that stores data to enable execution of processing specified from the processing execution request (Step S2102).

Then, the management apparatus 101 transmits an instruction to execute processing P specified from the processing execution request to the specified edge apparatus E (Step S2103). Then, the management apparatus 101 determines whether or not correction information about the state of the edge apparatus E or a process completion notification has been received from the edge apparatus E (Step S2104).

The management apparatus 101 waits to receive the correction information or the processing completion notification (Step S2104: No). When having received the correction information or the process completion notification (Step S2104: Yes), the management apparatus 101 determines whether or not all the processing is completed (Step S2105). The completion of all the processing indicates that all the processing P of each edge apparatus E that has transmitted the execution instruction is completed.

When all the processing is not completed (Step S2105: No), the management apparatus 101 calculates a predicted processing completion time for the edge apparatus E based on the received correction information or processing completion notification (Step S2106). When the processing completion notification is received, the predicted processing completion time for the edge apparatus E is the time t included in the processing completion notification.

Then, the management apparatus 101 updates the edge state information of the edge apparatus Ei in the edge state DB 160 using the predicted processing completion time calculated (Step S2107). When there is no corresponding record in the edge state DB 160, a new record corresponding to the edge apparatus Ei is created.

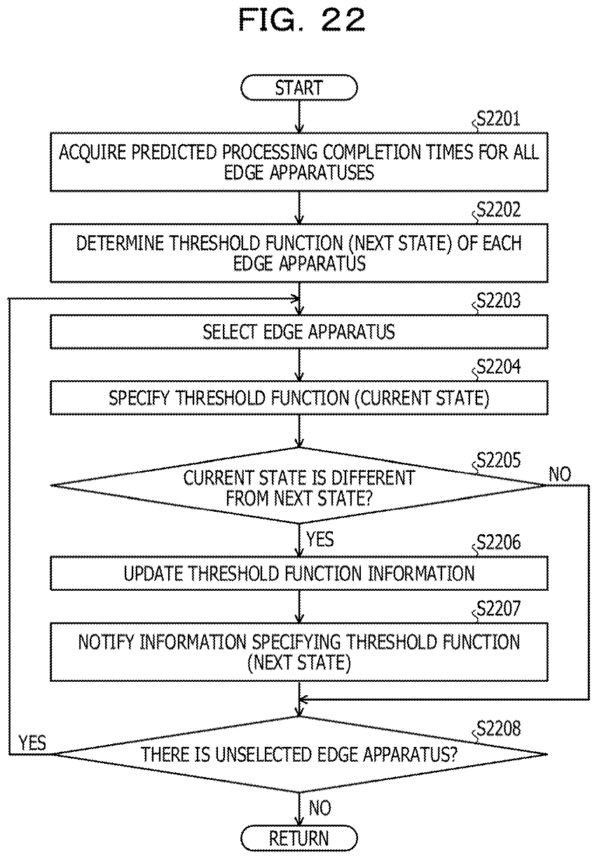

Next, the management apparatus 101 executes threshold control processing (Step S2108) and returns to Step S2104. A specific processing procedure of the threshold control processing will be described later with reference to FIG. 22. In Step S2105, when all the processing is completed (Step S2105: Yes), the management apparatus 101 terminates the series of processing according to this flowchart.

Accordingly, the state of each edge apparatus E recognized by the management apparatus 101 may be updated based on the correction information about the state of each edge apparatus E notified from the edge apparatus E.

Next, a specific processing procedure of the threshold control processing in Step S2108 illustrated in FIG. 21 will be described with reference to FIG. 22.

FIG. 22 is a flowchart illustrating an example of a specific processing procedure of the threshold control processing. In the flowchart illustrated in FIG. 22, the management apparatus 101 first refers to the edge state DB 160 to acquire predicted processing completion times of all the edge apparatuses E (Step S2201). Then, the management apparatus 101 determines a threshold function (next state) for each edge apparatus E based on the acquired predicted processing completion time of each edge apparatus E (Step S2202).

Thereafter, the management apparatus 101 selects an unselected edge apparatus E that is yet to be selected from among one or more edge apparatuses E that have transmitted the execution instructions (Step S2203). Then, the management apparatus 101 refers to the threshold function information DB 1900 to specify a threshold function (current state) of the selected edge apparatus E (Step S2204).

Next, the management apparatus 101 determines whether or not the specified threshold function (current state) differs from the determined threshold function (next state) (Step S2205). When the threshold function (current state) is the same as the threshold function (next state) (Step S2205: No), the management apparatus 101 proceeds to Step S2208.

On the other hand, when the threshold function (current state) differs from the threshold function (next state) (Step S2205: Yes), the management apparatus 101 uses the determined threshold function (next state) to update the threshold function information in the threshold function information DB 1900 for the selected edge apparatus E (Step S2206).

Then, the management apparatus 101 notifies the selected edge apparatus E of information that specifies the determined threshold function (next state) (Step S2207). Thereafter, the management apparatus 101 determines whether or not there is any unselected edge apparatus E that is yet to be selected from among one or more edge apparatuses E that have transmitted the execution instructions (Step S2208).

When there is any unselected edge apparatus E (Step S2208: Yes), the management apparatus 101 returns to Step S2203. On the other hand, when there is no unselected edge apparatus E (Step S2208: No), the management apparatus 101 terminates the series of processing according to this flowchart.

Thus, the threshold function for adjusting the threshold Th in each edge apparatus E may be controlled according to the predicted processing completion time of each edge apparatus E that has transmitted the execution instruction.

As described above, the management apparatus 101 according to Embodiment 2 may calculate (predict) the completion time of the processing (predicted processing completion time) in each edge apparatus E, based on the correction information notified from each of the plurality of edge apparatuses E. The management apparatus 101 may also determine a threshold function that defines the correspondence between the completion rate of the processing P and the threshold Th for each edge apparatus E based on the calculated (predicted) processing completion time of each edge apparatus E, and may notify each edge apparatus E of information that specifies the determined threshold function. Each edge apparatus E may adjust the threshold Th according to the threshold function specified from the information notified from the management apparatus.

Thus, the threshold function for adjusting the threshold Th in each edge apparatus E may be controlled according to the time when the processing P is expected to be completed in each edge apparatus E. Thus, an increase in communication traffic may be reduced by suppressing the frequency of notifying the correction information from each edge apparatus E while maintaining the prediction accuracy for the time when all the processing is completed.

For example, as for one or more edge apparatuses E having a relatively late predicted processing completion time among the plurality of edge apparatuses E, the management apparatus 101 may determine a threshold function that defines a correspondence that the higher the completion rate of the processing P (processing completion rate), the smaller the threshold Th. Accordingly, it is possible to specifically grasp the processing completion time for the edge apparatus E that requires longest processing time and the edge apparatus E likely to be the one that requires longest processing time.

As for the edge apparatuses E other than one or more edge apparatuses E having a relatively late predicted processing completion time among the plurality of edge apparatuses E, the management apparatus 101 may determine a threshold function having a fixed threshold Th for the completion rate of the processing P. As a result, for the edge apparatus E expected to complete the processing immediately, it is possible to reduce the communication traffic by roughly grasping the processing completion time.

The information processing method described in this embodiment may be realized by executing a program prepared in advance on a computer such as a personal computer or a workstation. The information processing program described according to the present embodiment is recorded on a computer-readable recording medium such as a hard disk, a flexible disk, a compact disc read-only memory (CD-ROM), a digital versatile disc (DVD), or a Universal Serial Bus (USB) memory and is executed as a result of being read from the recording medium by a computer. Also, the information processing program may be distributed via a network such as the Internet.

In addition, the management apparatus 101 and the edge apparatus Ei described in the embodiments may be realized by an application specific IC, such as a standard cell or a structured application specific integrated circuit (ASIC), or a programmable logic device (PLD), such as a field-programmable gate array (FPGA).

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A state management system comprising:
an information processing apparatus including:
a first memory, and
a first processor coupled to the first memory and the first processor configured to execute processing; and
a management apparatus including:
a second memory, and
a second processor coupled to the second memory and the second processor configured to predict a completion time of the processing in the information processing apparatus in accordance with information transmitted from the information processing apparatus wherein the first processor is configured to
determine, in accordance with a completion rate of the processing, a threshold for a difference between a first state of the information processing apparatus recognized by the information processing apparatus and a second state of the information processing apparatus recognized by the management apparatus, and
transmit information on the first state to the management apparatus when the difference exceeds the threshold.

2. The state management system according to claim 1, wherein
the threshold is changed such that the threshold decreases as the completion rate of the processing increases.

3. The state management system according to claim 1, wherein
the information includes the completion rate of the processing at a specific timing and information indicating a change rate of the completion rate of the processing, and
the first processor is configured to determine a method for calculating the change rate in accordance with the completion rate of the processing at the specific timing.

4. The state management system according to claim 3, wherein
the change rate is calculated based on the completion rate of the processing at the specific timing and an elapsed time from a start of the processing to the specific timing when the completion rate of the processing at the specific timing is not more than another threshold, and
the change rate is calculated based on the completion rate of the processing at the specific timing and the completion rate of the processing at another specific timing prior to the specific timing when the completion rate of the processing at the specific timing is more than the other threshold.

5. The state management system according to claim 1, comprising:
one or more information processing apparatuses, wherein
the second processor is configured to:
predict a completion time of processing in each of the one or more information processing apparatuses based on other information transmitted from each of the one or more information processing apparatuses,
perform determination of a threshold function that defines a correspondence between the completion rate of the processing and the threshold, for each of the one or more information processing apparatus, in accordance with a predicted completion time of the processing of each of the one or more information processing apparatuses, and
transmit the determined threshold function to each of the one or more information processing apparatuses,
each of the one or more information processing apparatus is configured to change the threshold in accordance with the threshold function.

6. The state management system according to claim 5, wherein
the determination of the threshold function includes
determining the threshold function that defines a relationship in which the completion rate of the processing increases as the threshold decreases, for at least one information processing apparatus having a relatively late predicted completion time of the processing among the one or more information processing apparatuses, and
determining the threshold function having a fixed threshold for the one or more information processing apparatuses except for the at least one information processing apparatus.

7. A computer-implemented state management method comprising:
executing, by an information processing apparatus, processing;
predicting, by a management apparatus, a completion time of the processing in the information processing apparatus in accordance with first information transmitted from the information processing apparatus;
determine, by the information processing apparatus in accordance with a completion rate of the processing, a threshold for a difference between a first state of the information processing apparatus recognized by the information processing apparatus and a second state of the information processing apparatus recognized by the management apparatus; and
transmit, by the information processing apparatus, second information for correcting the difference to the management apparatus when the difference exceeds the threshold.

8. The state management method according to claim 7, wherein
the threshold is changed such that the threshold decreases as the completion rate of the processing increases.

9. The state management method according to claim 7, wherein
the second information includes the completion rate of the processing at a specific timing and information indicating a change rate of the completion rate of the processing, and
the state management method further includes determining, by the information processing apparatus, a method for calculating the change rate in accordance with the completion rate of the processing at the specific timing.

10. The state management method according to claim 9, wherein
the change rate is calculated based on the completion rate of the processing at the specific timing and an elapsed time from a start of the processing to the specific timing when the completion rate of the processing at the specific timing is not more than another threshold, and
the change rate is calculated based on the completion rate of the processing at the specific timing and the completion rate of the processing at another specific timing prior to the specific timing when the completion rate of the processing at the specific timing is more than the other threshold.

11. The state management method according to claim 7, further comprising:
predicting, by a management apparatus, a completion time of processing in each of one or more information processing apparatuses based on third information transmitted from each of the one or more information processing apparatuses,
determining, by a management apparatus, a threshold function that defines a correspondence between the completion rate of the processing and the threshold, for each of the one or more information processing apparatus, in accordance with a predicted completion time of the processing of each of the one or more information processing apparatuses; and
transmitting, by a management apparatus, the determined threshold function to each of the one or more information processing apparatuses,
changing, by the one or more information processing apparatuses, the threshold in accordance with the threshold function.

12. The state management method according to claim 11, wherein
the determining of the threshold function includes
determining the threshold function that defines a relationship in which the completion rate of the processing increases as the threshold decreases, for at least one information processing apparatus having a relatively late predicted completion time of the processing among the one or more information processing apparatuses, and
determining the threshold function having a fixed threshold for the one or more information processing apparatuses except for the at least one information processing apparatus.

13. An information processing apparatus comprising:
a memory; and
a processor coupled to the memory and the processor configured to:
execute processing,
when detecting that a difference between an actual progress of the processing and a progress of the processing predicted by the management apparatus exceeds a threshold, transmit information for correcting the difference to a management apparatus, and
determine the threshold in accordance with the actual progress of the processing.
